(19) United States
(12) Patent Application Publication
(10) Pub. No.: US 2026/0001454 A1
(43) Pub. Date: Jan. 1, 2026

(54) ADJUSTABLE SEAT BACK AND CUSHION METHOD

(71) Applicants: Hyundai Motor Company, Seoul (KR); Kia Corporation, Seoul (KR); Lear Corporation, Southfield, MI (US)

(72) Inventors: Scott Ziolek, Ann Arbor, MI (US); Stephen Redwood, Flat Rock, MI (US); Mahendra Nechawala, Pune (IN); Imran Mohammed, Karnataka (IN); Adarsha B. Madhu, Novi, MI (US); Gopal Kalburgi, Belgaum (IN)

(21) Appl. No.: 18/755,144

(22) Filed: Jun. 26, 2024

(51) Int. Cl. B60N 2/20; B60N 2/30; B60N 2/64; B60N 2/90

(52) U.S. Cl. CPC B60N 2/206; B60N 2/3047; B60N 2/64; B60N 2/919

(57) ABSTRACT

A vehicle seat structure and methods of use are provided. The vehicle seat structure may comprise a seat back assembly comprising a seat back frame and one or more seat back brackets, and a seat mount assembly comprising one or more mounting brackets, a lateral structural beam, and one or more coupling ramps coupled to the one or more mounting brackets. The one or more mounting brackets may be coupled to left and right sides of the lateral structural beam and pivotably attached to the one or more seat back brackets. The vehicle seat structure may comprise a seat cushion assembly comprising a cushion frame and one or more cushion brackets, coupled to the cushion frame, pivotably attached to the one or more seat back brackets. The vehicle seat structure may comprise one or more pivot latch mechanisms for the seat back pivot and the seat cushion pivot.

### BACKGROUND

### Technical Field

Embodiments of the present disclosure relate to adjustable vehicle seat structures and methods of use.

### Background

The amount of cargo space and passenger space for consumer vehicle is an important factor in choosing which vehicle to purchase. Consumers demand cargo management flexibility for a variety of different load cases and need seats with flexibility to take advantage of new interior designs in order to carry passengers, store cargo, or open up interior vehicle space.

The potential for flat floors within an interior achieved by an electric vehicle (EV) powertrain will only increase the demand for more reconfigurable interior features. In EVs, the deletion of the gas tank and center tunnel has particular impact on the 2nd and 3rd row occupant areas.

Many competitive seats with flip up cushion capability utilize a front leg or bin to support the cushion in a seated condition. However, this interferes with potential storage space below the seat. As the front leg disconnects or slides during the fold operation, the cushion nose can drag across the floor. Competitive seats with a floating cushion (e.g., no front leg support) do not also have a fold and dive configuration. For example, the seat back may recline, but not with a cushion dive.

### SUMMARY

According to an object of the present disclosure, a vehicle seat structure is provided. The vehicle seat structure may comprise a seat back assembly. The seat back assembly may comprise a seat back frame and one or more seat back brackets. The seat back frame may be coupled to the one or more seat back brackets. The vehicle seat structure may comprise a seat mount assembly. The seat mount assembly may comprise one or more mounting brackets, a lateral structural beam, and one or more coupling ramps coupled to the one or more mounting brackets. The one or more mounting brackets may be coupled to left and right sides of the lateral structural beam, mounted to a floor of a vehicle, and pivotably attached to the one or more seat back brackets, forming a seat back pivot. The vehicle seat structure may comprise a seat cushion assembly. The seat cushion assembly may comprise a cushion frame and one or more cushion brackets, coupled to the cushion frame, pivotably attached to the one or more seat back brackets, forming a seat cushion pivot. The vehicle seat structure may comprise one or more pivot latch mechanisms for the seat back pivot and the seat cushion pivot. The seat cushion assembly may be is configured to be rotated down at the seat cushion pivot to a mostly horizontal condition, and may be supported by the one or more cushion brackets resting against the lateral structural beam. The seat back assembly may be configured to be folded down at the seat back pivot to a mostly horizontal condition.

According to an exemplary embodiment, the seat back assembly may be configured to be folded down by deactivating one or more of the one or more pivot latch mechanisms.

According to an exemplary embodiment, folding down the seat back may cause the cushion pivot to also rotate forward and dive down, causing the cushion bracket to drop from the lateral structural beam to the one or more coupling ramps.

According to an exemplary embodiment, the cushion assembly may be configured to be supported by the one or more cushion brackets resting on the one or more coupling ramps when the seat back is folded down at the seat back pivot to the mostly horizontal condition.

According to an exemplary embodiment, the seat cushion assembly may further comprise a cushion component.

According to an exemplary embodiment, the cushion component may be positioned within the cushion frame.

According to an exemplary embodiment, the cushion component may comprise one or more springs.

According to an exemplary embodiment, the seat cushion assembly may be configured to be rotated up at the seat cushion pivot to a mostly vertical condition.

According to an exemplary embodiment, the seat cushion assembly may be configured to be supported by one or more of the one or more pivot latch mechanisms.

According to an exemplary embodiment, the seat back assembly may be configured to be folded up at the seat back pivot to a mostly vertical condition.

According to an object of the present disclosure, a vehicle seat structure is provided. The vehicle seat structure may comprise a seat back assembly comprising one or more seat back brackets, and a seat mount assembly comprising one or more mounting brackets, a lateral structural beam, and one or more coupling ramps coupled to the one or more mounting brackets. The one or more mounting brackets may be coupled to left and right sides of the lateral structural beam, mounted to a floor of a vehicle, and pivotably attached to the one or more seat back brackets, forming a seat back pivot. The vehicle seat structure may comprise a seat cushion assembly comprising one or more cushion brackets pivotably attached to the one or more seat back brackets, forming a seat cushion pivot, and one or more pivot latch mechanisms releasable latches for the seat back pivot and the seat cushion pivot. The seat cushion assembly may be configured to be rotated down at the seat cushion pivot to a mostly horizontal condition, and may be supported by the one or more cushion brackets resting against the lateral structural beam. The seat back assembly may be configured to be folded down at the seat back pivot to a mostly horizontal condition.

According to an exemplary embodiment, the seat back assembly may be configured to be folded down by deactivating one or more of the one or more pivot latch mechanisms.

According to an exemplary embodiment, folding down the seat back may cause the cushion pivot to also rotate forward and dive down, causing the cushion bracket to drop from the lateral structural beam to the one or more coupling ramps.

According to an exemplary embodiment, the cushion assembly may be configured to be supported by the one or more cushion brackets resting on the one or more coupling ramps when the seat back is folded down at the seat back pivot to the mostly horizontal condition.

According to an exemplary embodiment, the seat cushion assembly may further comprise a cushion component.

According to an exemplary embodiment, the seat cushion assembly may comprise a cushion frame, and the cushion component may be positioned within the cushion frame.

According to an exemplary embodiment, the cushion component may comprise one or more springs.

According to an exemplary embodiment, the seat cushion assembly may be configured to be rotated up at the seat cushion pivot to a mostly vertical condition.

According to an exemplary embodiment, the seat cushion assembly may be configured to be supported by one or more of the one or more pivot latch mechanisms.

According to an exemplary embodiment, the seat back assembly may be configured to be folded up at the seat back pivot to a mostly vertical condition.

### BRIEF DESCRIPTION OF THE DRAWINGS

The accompanying drawings, which are incorporated in and form a part of the Description of Embodiments, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 illustrates a vehicle seat structure in an exploded view, according to an exemplary embodiment of the present disclosure.

FIGS. 2A-2B illustrate a perspective view (FIG. 2A) and a side view (FIG. 2B) of a vehicle seat structure in a first configuration, according to an exemplary embodiment of the present disclosure.

FIGS. 3A-3B illustrate a perspective view (FIG. 3A) and a side view (FIG. 3B) of a vehicle seat structure in a second configuration, according to an exemplary embodiment of the present disclosure.

FIGS. 4A-4B illustrate a perspective view (FIG. 4A) and a side view (FIG. 4B) of a vehicle seat structure in a third configuration, according to an exemplary embodiment of the present disclosure.

FIGS. 5A-5C illustrate views of a vehicle seat structure adjusting from a seating condition (FIG. 5A) to a fold and dive condition (FIG. 5C), according to an exemplary embodiment of the present disclosure.

FIGS. 6A-6C illustrate views of a vehicle seat structure adjusting from a fold and dive condition (FIG. 6A) to a seating condition (FIG. 6C), according to an exemplary embodiment of the present disclosure.

FIGS. 7A-7C illustrate views of a vehicle seat structure adjusting from a seating condition (FIG. 7A) to a flip-up/stadium seating condition (FIG. 7C), according to an exemplary embodiment of the present disclosure.

FIGS. 8A-8C illustrate views of a vehicle seat structure adjusting from a flip-up/stadium seating condition (FIG. 8A) to a seating condition (FIG. 8C), according to an exemplary embodiment of the present disclosure.

FIG. 9 illustrates example elements of a computing device, according to an exemplary embodiment of the present disclosure.

FIG. 10 illustrates an example architecture of a vehicle, according to an exemplary embodiment of the present disclosure.

### DETAILED DESCRIPTION

The following Description of Embodiments is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

Embodiments described herein provide an adjustable vehicle seat structure and methods of use.

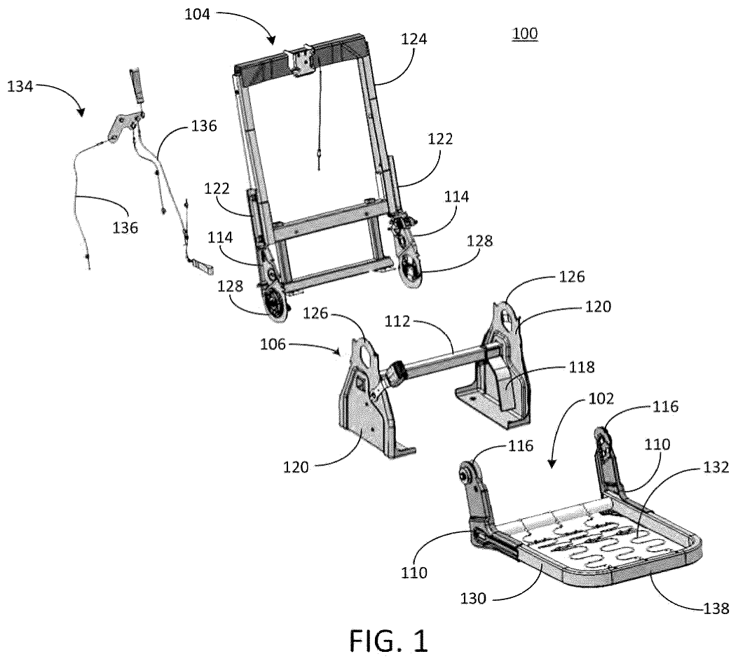

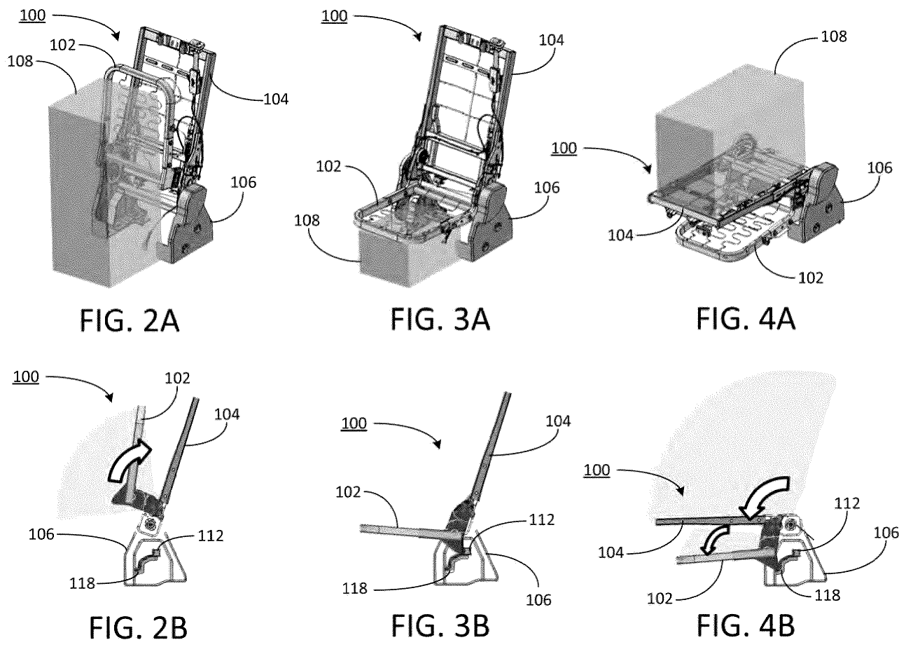

Referring now to FIGS. 1-4B, an adjustable vehicle seat structure 100 in an exploded view (FIG. 1), in a first configuration (FIGS. 2A-2B), in a second configuration (FIGS. 3A-3B), and in a third configuration (FIGS. 4A-4B) is illustratively depicted, in accordance with exemplary embodiments of the present disclosure.

According to an exemplary embodiment, the adjustable vehicle seat structure 100 may comprise a seat structure with a cantilever-type cushion support structure comprising a seat cushion assembly 102 and a seat back assembly 104 configured to rotate around a seat mount assembly 106. According to an exemplary embodiment, the cantilever-type support structure does not comprise a front leg. According to various embodiments, the vehicle seat structure 100 may be configured to adjust to at least 3 configurations.

For example, according to an exemplary embodiment, in a first configuration, as shown, e.g., in FIGS. 2A-2B, the vehicle seat structure 100 may be in a flip-up/stadium seating cargo condition in which the seat cushion assembly 102 and the seat back assembly 104 are both folded up about the seat mount assembly 106. In the first configuration, the vehicle seat structure 100 may be configured such that cargo 108 may be stored in front of the seat cushion assembly 102. According to an exemplary embodiment, a cushion bracket 110 (e.g., but not limited to, an L-bracket, a T-bracket, and/or other suitable bracket) may be rotated away from a lateral structural beam 112 so that the seat cushion assembly 102 may be supported by a cushion pivot 114 and pivot latch mechanism 116.

According to an exemplary embodiment, in a second configuration, as shown, e.g., in FIGS. 3A-3B, the vehicle seat structure 100 may be in a seating condition in which the seat cushion assembly 102 is folded down and the seat back assembly 104 is folded up about the seat mount assembly 106. In the second configuration, the vehicle seat structure 100 may be configured such that cargo 108 may be stored under the seat cushion assembly 102 while an occupant is seated on the seat cushion assembly 102. According to an exemplary embodiment, in the second configuration, the vehicle seat structure 100 may be configured such that the seat cushion assembly 102 may be supported by the cushion pivot 114 and the cushion bracket 110 on the lateral structural beam 112.

According to an exemplary embodiment, in a third configuration, as shown, e.g., in FIGS. 4A-4B, the vehicle seat structure 100 may be in a fold and dive cargo condition in which the seat cushion assembly 102 and the seat back assembly 104 are both folded down about the seat mount assembly 106. In the third configuration, the vehicle seat structure 100 may be configured such that the cargo 108 may be stored on top of the folded down seat back assembly 104. According to an exemplary embodiment, in the third configuration, the vehicle seat structure 100 may be configured such that the seat cushion assembly may be supported by the cushion pivot 114 and the cushion bracket may be configured to slide across a coupling ramp 118.

According to an exemplary embodiment, the seat mount assembly 106 may comprise left and right seat mount brackets 120. The seat mount brackets 120 may be configured to be mounted/attached to a vehicle floor of a vehicle. The seat mount assembly 106 may comprise the lateral structural beam 112, attaching the left and right seat mount brackets 120, and the one or more coupling ramps 118. The one or more coupling ramps 118 may be configured to be attached to sides of each seat mount bracket 120.

According to an exemplary embodiment, the seat back assembly 104 may comprise one or more seat back brackets 122 pivotably connected to the left and right seat mount brackets 120. The seat mount assembly 106 may comprise a seat back frame 124. The seat back frame 124 may be configured to be attached to the seat back brackets 122. According to an exemplary embodiment, the seat back frame 124 and the seat back brackets 122 may be a singular piece or separate pieces. According to an exemplary embodiment, the seat back assembly 104 may comprise one or more pivot points comprising a pivot latch mechanism 128. The pivot latch mechanism 128 may comprise a releasable latch configured to secure the seat back assembly 104 in the seated condition.

According to an exemplary embodiment, the seat cushion assembly 102 may comprise one or more cushion brackets 110. The cushion bracket 110 may be configured to be pivotably connected to one or more seat back brackets 122. According to an exemplary embodiment, the seat cushion assembly 102 may comprise a wheel on the cushion bracket 110 to reduce friction. According to an exemplary embodiment, the seat cushion assembly 102 may comprise a seat cushion frame 130. According to an exemplary embodiment, the seat cushion frame 130 may be coupled to the one or more cushion brackets 110. According to an exemplary embodiment, the seat cushion assembly 102 may comprise one or more pivot points 114 comprising a pivot latch mechanism 116. The pivot latch mechanism 116 may comprise a releasable latch configured to secure the seat cushion assembly 102 in down and flip-up conditions. According to an exemplary embodiment, the seat cushion assembly 102 may comprise a cushion component 132 configured to provide support to a user sitting on the seat cushion assembly 102. According to an exemplary embodiment, the cushion component may be positioned within the seat cushion frame 130. The cushion component 132 may comprise foam, one or more springs, and/or other suitable cushion components configured to cushion the seat cushion assembly 102.

According to an exemplary embodiment, the vehicle seat structure 100 may comprise a cable junction 134. The cable junction 134 may comprise one or more release cables 136 for disengaging the releasable pivot latch mechanisms 116, 128 on the seat cushion assembly 102 and the seat back assembly 104 when the pivot latch mechanisms 116, 128 are released.

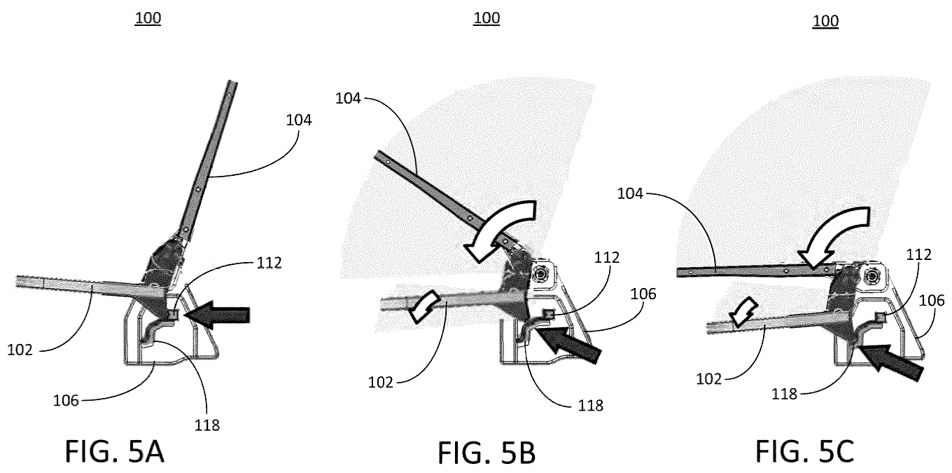

Referring now to FIGS. 5A-5C, views of a vehicle seat structure 100 adjusting from a seating condition (FIG. 5A) to a fold and dive condition (FIG. 5C) are illustratively depicted, in accordance with an exemplary embodiment of the present disclosure.

In the seating condition, as shown, e.g., in FIG. 5A, the cushion bracket 110 rests against the lateral structural beam 112. According to an exemplary embodiment, to adjust the vehicle seat structure 100 from the seating condition (as shown, e.g., FIG. 5A) to the fold and dive condition (as shown, e.g., in FIG. 5C), a user may release the seat back pivot latch mechanism 128. This may also release the seat cushion pivot latch mechanism 116. This enables the seat back assembly 104 to fold forward, which also rotates the seat cushion pivot 114, as shown, e.g., in FIG. 5B. The cushion bracket 110 slides down from the lateral structural beam 112 to the shaped coupling ramp 118 holding a nose 138 of the seat cushion assembly 102 forward as it dives, resulting in the cushion bracket 110 resting on the coupling ramp 118, as shown, e.g., in FIG. 5C.

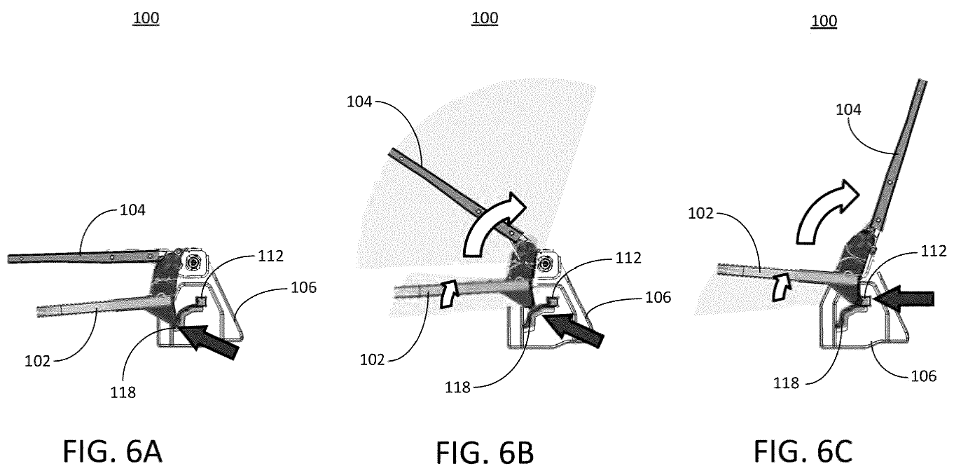

Referring now to FIGS. 6A-6C, views of a vehicle seat structure 100 adjusting from a fold and dive condition (FIG. 6A) to a seating condition (FIG. 6C) are illustratively depicted, in accordance with an exemplary embodiment of the present disclosure.

In the fold and dive condition, as shown, e.g., in FIG. 6A, the cushion bracket 110 rests on the coupling ramp 118. According to an exemplary embodiment, to adjust the vehicle seat structure 100 from the fold and dive condition (as shown, e.g., in FIG. 6A) to the seating condition (as shown, e.g., in FIG. 6C), a user may lift the seat back assembly 104 to return the vehicle seat structure 100 to the seating condition. As the seat back assembly 104 is lifted, as shown, e.g., in FIG. 6B, the seat cushion pivot 114 also rotates up and rearward. The cushion bracket 110 may slide up the shaped coupling ramp 118 and onto the lateral structural beam 112 holding the seat cushion nose 138 forward as it the vehicle seat structure 100 returns to the seating condition. The cushion bracket 110 may then return to its position in the seating condition and rests against the lateral structural beam 112, and the pivot latch mechanisms 116, 128 of the seat cushion assembly 102 and the seat back assembly 104 may then reconnect.

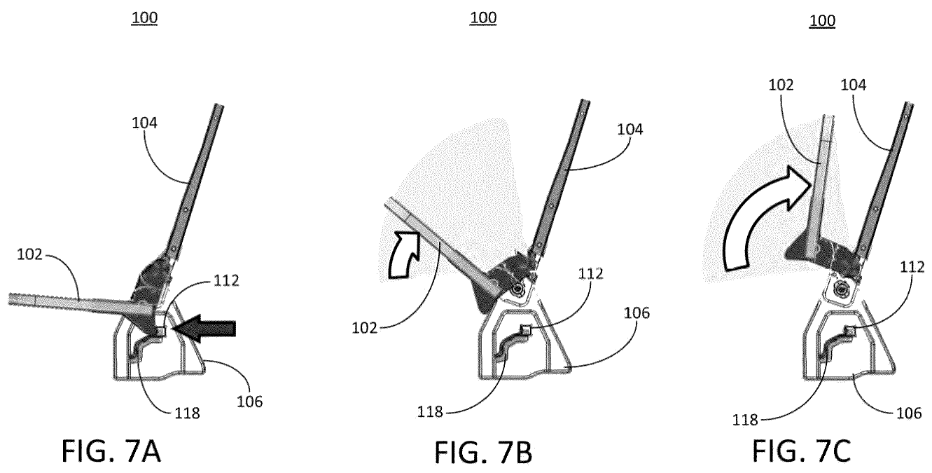

Referring now to FIGS. 7A-7C, views of a vehicle seat structure 100 adjusting from a seating condition (FIG. 7A) to a flip-up/stadium condition (FIG. 7C) are illustratively depicted, in accordance with an exemplary embodiment of the present disclosure.

In the seating condition, as shown, e.g., in FIG. 7A, the cushion bracket 110 rests against the lateral structural beam 112. According to an exemplary embodiment, to adjust the vehicle seat structure 100 from the seating condition (as shown, e.g., FIG. 7A) to the fold-up/stadium condition (as shown, e.g., in FIG. 7C), a user may release the seat cushion pivot latch mechanism 116. The user may then lift the seat cushion assembly 102 up off of the lateral structural beam 112, as shown, e.g., in FIG. 7B, and rotate the seat cushion assembly 102 around the cushion pivot 114. The seat cushion assembly 102 rotates up to the seat back assembly 104, and the cushion pivot latch mechanism 116 connects to secure the seat cushion assembly 102, causing the vehicle seat structure 100 to be in the flip-up/stadium condition.

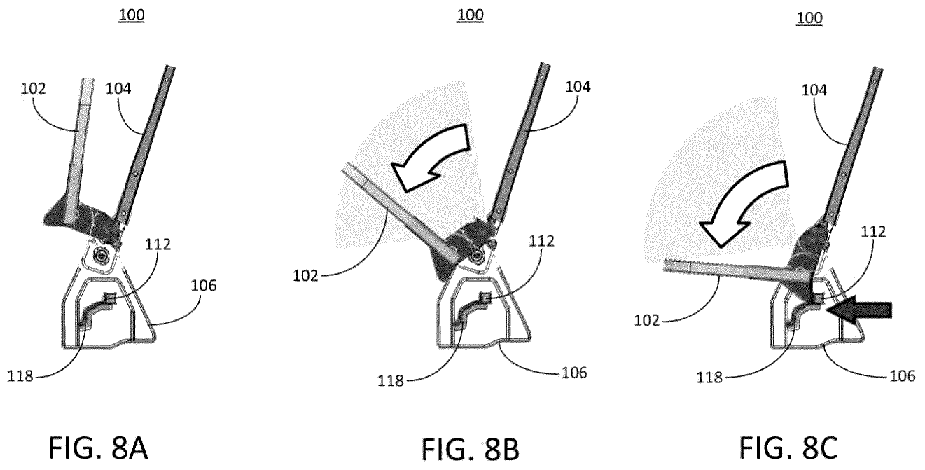

Referring now to FIGS. 8A-8C, views of a vehicle seat structure 100 adjusting from a flip-up/stadium condition (FIG. 8A) to a seating condition (FIG. 8C) are illustratively depicted, in accordance with an exemplary embodiment of the present disclosure.

In the flip-up/stadium condition, as shown, e.g., in FIG. 8A, the cushion pivot latch mechanism 116 secures the seat cushion assembly 102 in the flip-up/stadium configuration. According to an exemplary embodiment, to adjust the vehicle seat structure 100 from the flip-up/stadium condition (as shown, e.g., in FIG. 8A) to the seating condition (as shown, e.g., in FIG. 8C), a user may release the cushion latch mechanism 116, enabling the user to lower the seat cushion assembly 102 down, rotating the seat cushion assembly 102 around the cushion pivot 114 (as shown, e.g., in FIG. 8B). The seat cushion assembly 102 may rotate down until the cushion bracket 110 rests against the lateral structural beam 112. The cushion pivot latch mechanism 116 may then connect to secure the position of the seat cushion assembly 102, causing the vehicle seat structure 100 to be in the seating condition.

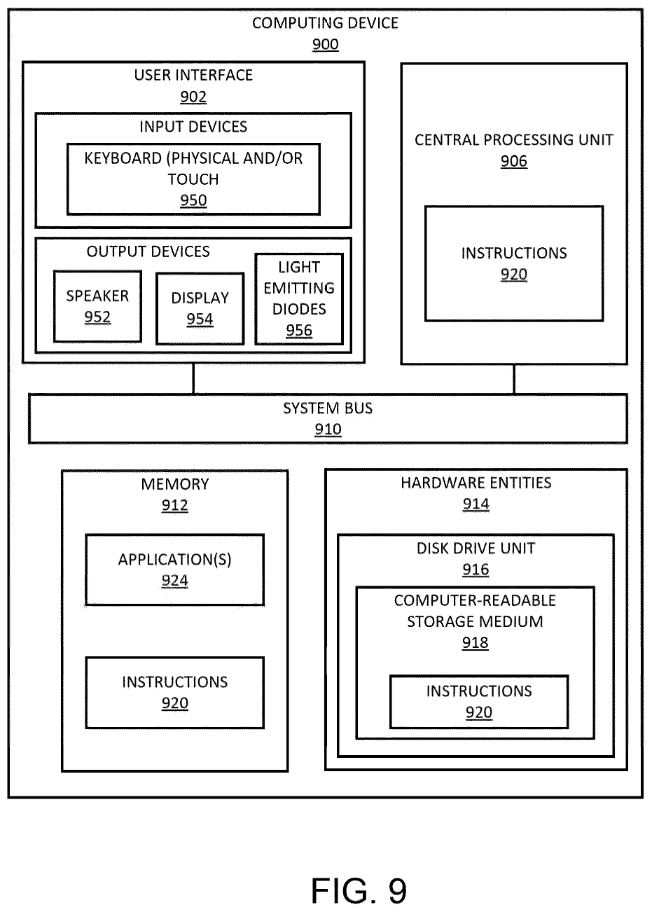

According to various embodiments, the vehicle seat structure 100 may be configured to adjust between the at least three configurations via manual adjustment and/or through powered means. According to an exemplary embodiment, the powered means may comprise one or more actuators and/or other means of movement of one or more components of the vehicle seat structure 100. According to an exemplary embodiment, powered means may be controlled by one or more computing devices (e.g., computing device 900 as shown, e.g., in FIG. 9).

Referring now to FIG. 9, an illustration of an example architecture for a computing device 900 is provided. According to an exemplary embodiment, one or more functions of the present disclosure may be implemented by a computing device such as, e.g., computing device 900 or a computing device similar to computing device 900.

The hardware architecture of FIG. 9 represents one example implementation of a representative computing device configured to perform one or more methods and means for controlling and/or adjusting a vehicle seat structure (e.g., vehicle seat structure 100), as described herein. As such, the computing device 900 of FIG. 9 may be configured to implement at least a portion of the mechanical adjustments described herein and/or shown, e.g., in FIGS. 1-8C.

Some or all components of the computing device 900 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 9, the computing device 900 may comprise a user interface 902, a Central Processing Unit (“CPU”) 906, a system bus 910, a memory 912 connected to and accessible by other portions of computing device 900 through system bus 910, and hardware entities 914 connected to system bus 910. The user interface may comprise input devices and output devices, which may be configured to facilitate user-software interactions for controlling operations of the computing device 900. The input devices may comprise, but are not limited to, a physical and/or touch keyboard 940. The input devices may be connected to the computing device 900 via a wired or wireless connection (e.g., a Bluetooth® connection). The output devices may comprise, but are not limited to, a speaker 942, a display 944, and/or light emitting diodes 946.

At least some of the hardware entities 914 may be configured to perform actions involving access to and use of memory 912, which may be a Random Access Memory (RAM), a disk driver and/or a Compact Disc Read Only Memory (CD-ROM), among other suitable memory types. Hardware entities 914 may comprise a disk drive unit 916 comprising a computer-readable storage medium 918 on which may be stored one or more sets of instructions 920 (e.g., programming instructions such as, but not limited to, software code) configured to implement one or more of the methodologies, procedures, or functions described herein. The instructions 920 may also reside, completely or at least partially, within the memory 912 and/or within the CPU 906 during execution thereof by the computing device 900.

The memory 912 and the CPU 906 may also constitute machine-readable media. The term “machine-readable media”, as used here, refers to a single medium or multiple media (e.g., a centralized or distributed database, and/or associated caches and servers) that store the one or more sets of instructions 920. The term “machine-readable media,” as used here, also refers to any medium that is capable of storing, encoding or carrying a set of instructions 920 for execution by the computing device 900 and that cause the computing device 900 to perform any one or more of the methodologies of the present disclosure.

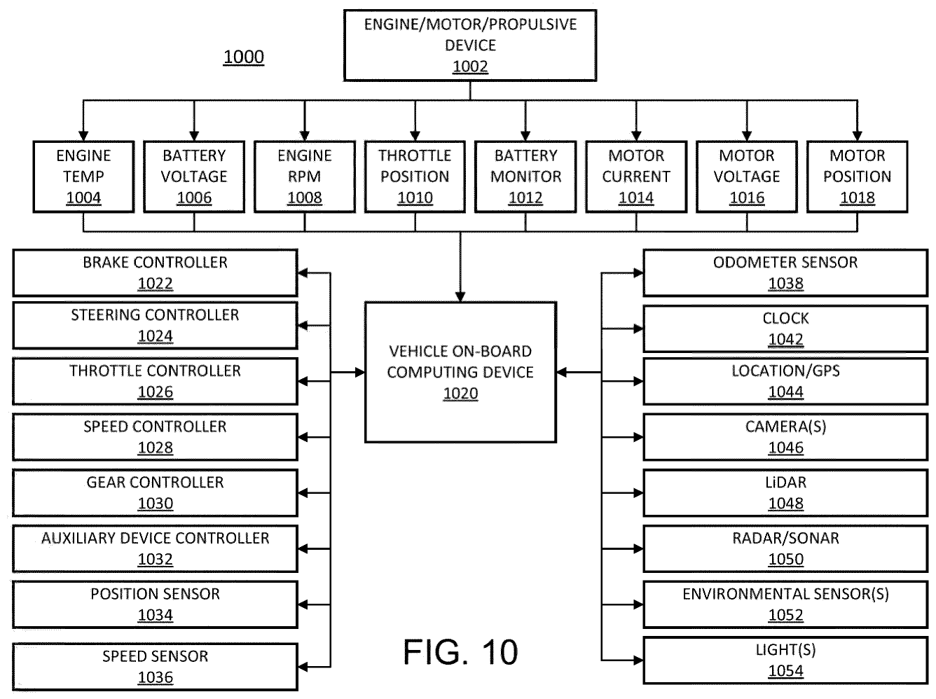

Referring now to FIG. 10, an example vehicle system architecture 1000 for a vehicle is provided, in accordance with an exemplary embodiment of the present disclosure.

According to an exemplary embodiment, vehicle seat structure 100 may be configured to be mounted/secured to a vehicle having the same or similar system architecture as that shown in FIG. 10.

As shown in FIG. 10, the vehicle system architecture 1000 may comprise an engine, motor or propulsive device (e.g., a thruster) 1002 and various sensors 1004-1018 for measuring various parameters of the vehicle system architecture 1000. In gas-powered or hybrid vehicles having a fuel-powered engine, the sensors 1004-1018 may comprise, for example, an engine temperature sensor 1004, a battery voltage sensor 1006, an engine Rotations Per Minute (RPM) sensor 1008, and/or a throttle position sensor 1010. If the vehicle is an electric or hybrid vehicle, then the vehicle may comprise an electric motor, and accordingly may comprise sensors such as a battery monitoring system 1012 (to measure current, voltage and/or temperature of the battery), motor current 1014 and voltage 1016 sensors, and motor position sensors such as resolvers and encoders 1018.

Operational parameter sensors that are common to both types of vehicles may comprise, for example: a position sensor 1034 such as an accelerometer, gyroscope and/or inertial measurement unit; a speed sensor 1036; and/or an odometer sensor 1038. The vehicle system architecture 1000 also may comprise a clock 1042 that the system uses to determine vehicle time and/or date during operation. The clock 1042 may be encoded into the vehicle on-board computing device 1020, it may be a separate device, or multiple clocks may be available.

The vehicle system architecture 1000 also may comprise various sensors that operate to gather information about the environment in which the vehicle is traveling. These sensors may comprise, for example: a location sensor 1044 (for example, a Global Positioning System (GPS) device); object detection sensors such as one or more cameras 1046; a LiDAR sensor system 1048; and/or a RADAR and/or a sonar system 1050. The sensors also may comprise environmental sensors 1052 such as, e.g., a humidity sensor, a precipitation sensor, a light sensor, and/or ambient temperature sensor. The object detection sensors may be configured to enable the vehicle system architecture 1000 to detect objects that are within a given distance range of the vehicle in any direction, while the environmental sensors 1052 may be configured to collect data about environmental conditions within the vehicle's area of travel. According to an exemplary embodiment, the vehicle system architecture 1000 may comprise one or more lights 1054 (e.g., headlights, flood lights, flashlights, etc.).

During operations, information may be communicated from the sensors to an on-board computing device 1020 (e.g., computing device 900 of FIG. 9). The on-board computing device 1020 may be configured to analyze the data captured by the sensors and/or data received from data providers and may be configured to optionally control operations of the vehicle system architecture 600 based on results of the analysis. For example, the on-board computing device 1020 may be configured to control: braking via a brake controller 1022; direction via a steering controller 1024; speed and acceleration via a throttle controller 1026 (in a gas-powered vehicle) or a motor speed controller 1028 (such as a current level controller in an electric vehicle); a differential gear controller 1030 (in vehicles with transmissions); and/or other controllers. The brake controller 1022 may comprise a pedal effort sensor, pedal effort sensor, and/or simulator temperature sensor, as described herein.

Geographic location information may be communicated from the location sensor 1044 to the on-board computing device 1020, which may then access a map of the environment that corresponds to the location information to determine known fixed features of the environment such as streets, buildings, stop signs and/or stop/go signals. Captured images from the cameras 1046 and/or object detection information captured from sensors such as LiDAR 1048 may be communicated from those sensors to the on-board computing device 1020. The object detection information and/or captured images may be processed by the on-board computing device 1020 to detect objects in proximity to the vehicle. Any known or to be known technique for making an object detection based on sensor data and/or captured images may be used in the embodiments disclosed in this document.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A vehicle seat structure, comprising:
a seat back assembly comprising:
a seat back frame; and
one or more seat back brackets,
wherein the seat back frame is coupled to the one or more seat back brackets;
a seat mount assembly comprising:
one or more mounting brackets;
a lateral structural beam,
wherein the one or more mounting brackets are:
coupled to left and right sides of the lateral structural beam;
mounted to a floor of a vehicle; and
pivotably attached to the one or more seat back brackets, forming a seat back pivot; and
one or more coupling ramps coupled to the one or more mounting brackets;
a seat cushion assembly comprising:
a cushion frame; and
one or more cushion brackets, coupled to the cushion frame, pivotably attached to the one or more seat back brackets, forming a seat cushion pivot; and
one or more pivot latch mechanisms for the seat back pivot and the seat cushion pivot, wherein:
the seat cushion assembly:
is configured to be rotated down at the seat cushion pivot to a mostly horizontal condition; and
is supported by the one or more cushion brackets resting against the lateral structural beam,
the seat back assembly is configured to be folded down at the seat back pivot to a mostly horizontal condition.

2. The vehicle seat structure of claim 1, wherein the seat back assembly is configured to be folded down by deactivating one or more of the one or more pivot latch mechanisms.

3. The vehicle seat structure of claim 1, wherein folding down the seat back causes the cushion pivot to also rotate forward and dive down, causing the cushion bracket to drop from the lateral structural beam to the one or more coupling ramps.

4. The vehicle seat structure of claim 1, wherein the cushion assembly is configured to be supported by the one or more cushion brackets resting on the one or more coupling ramps when the seat back is folded down at the seat back pivot to the mostly horizontal condition.

5. The vehicle seat structure of claim 1, wherein the seat cushion assembly further comprises a cushion component.

6. The vehicle seat structure of claim 5, wherein the cushion component is positioned within the cushion frame.

7. The vehicle seat structure of claim 5, wherein the cushion component comprises one or more springs.

8. The vehicle structure of claim 1, wherein the seat cushion assembly is configured to be rotated up at the seat cushion pivot to a mostly vertical condition.

9. The vehicle structure of claim 8, wherein the seat cushion assembly is configured to be supported by one or more of the one or more pivot latch mechanisms.

10. The vehicle structure of claim 8, wherein the seat back assembly is configured to be folded up at the seat back pivot to a mostly vertical condition.

11. A vehicle seat structure, comprising:
a seat back assembly comprising one or more seat back brackets,
a seat mount assembly comprising:
one or more mounting brackets;
a lateral structural beam,
wherein the one or more mounting brackets are:
coupled to left and right sides of the lateral structural beam;
mounted to a floor of a vehicle; and
pivotably attached to the one or more seat back brackets, forming a seat back pivot; and
one or more coupling ramps coupled to the one or more mounting brackets;
a seat cushion assembly comprising one or more cushion brackets pivotably attached to the one or more seat back brackets, forming a seat cushion pivot; and
one or more pivot latch mechanisms for the seat back pivot and the seat cushion pivot,
wherein:
the seat cushion assembly:
is configured to be rotated down at the seat cushion pivot to a mostly horizontal condition; and
is supported by the one or more cushion brackets resting against the lateral structural beam,
the seat back assembly is configured to be folded down at the seat back pivot to a mostly horizontal condition.

12. The vehicle seat structure of claim 11, wherein the seat back assembly is configured to be folded down by deactivating one or more of the one or more pivot latch mechanisms.

13. The vehicle seat structure of claim 11, wherein folding down the seat back causes the cushion pivot to also rotate forward and dive down, causing the cushion bracket to drop from the lateral structural beam to the one or more coupling ramps.

14. The vehicle seat structure of claim 11, wherein the cushion assembly is configured to be supported by the one or more cushion brackets resting on the one or more coupling ramps when the seat back is folded down at the seat back pivot to the mostly horizontal condition.

15. The vehicle seat structure of claim 11, wherein the seat cushion assembly further comprises a cushion component.

16. The vehicle seat structure of claim 15, wherein:
the seat cushion assembly comprises a cushion frame, and
the cushion component is positioned within the cushion frame.

17. The vehicle seat structure of claim 15, wherein the cushion component comprises one or more springs.

18. The vehicle structure of claim 11, wherein the seat cushion assembly is configured to be rotated up at the seat cushion pivot to a mostly vertical condition.

19. The vehicle structure of claim 18, wherein the seat cushion assembly is configured to be supported by one or more of the one or more pivot latch mechanisms.

20. The vehicle structure of claim 18, wherein the seat back assembly is configured to be folded up at the seat back pivot to a mostly vertical condition.
